(19) United States
(12) Patent Application Publication
(10) Pub. No.: US 2011/0271051 A1
(43) Pub. Date: Nov. 3, 2011

(54) ARRAY TYPE DISK DEVICE, AND CONTROL METHOD FOR ARRAY TYPE DISK DEVICE

(76) Inventors: Masaki Nakano, Tokyo (JP); Masatsugu Ogawa, Tokyo (JP)

(21) Appl. No.: 13/143,443

(22) PCT Filed: Jan. 20, 2010
(86) PCT No.: PCT/JP2010/050643

§ 371 Date: Jul. 6, 2011

(30) Foreign Application Priority Data
Jan. 21, 2009 (JP) 2009011434

(51) Int. Cl. G06F 12/08

(52) U.S. Cl. 711/114; 711/E12.019

(57) ABSTRACT

For the purpose of reducing the time for information processing in an array type disk device provided with a plurality of optical disk devices, when a beginning address is notified from any one of the optical disk devices to a main control device of the array type disk device, the main control device determines the beginning address notified first as a writing start address, without waiting for a notification of a beginning address from any other optical disk devices. Then, the main control device notifies the determined writing start address to the respective optical disk devices. Accordingly, even if search times for the writing start address are different among the optical disk devices, all the optical disk devices can start the writing of information based on which optical disk device has most quickly notified the beginning address.

### TECHNICAL FIELD

The present invention relates to an array type disk device and a control method for an array type disk device, and more particularly, an array type disk device that executes an information processing on a plurality of recording media, and a control method for the array type disk device that executes an information processing on a plurality of recording media.

### BACKGROUND ART

In recent years, together with an advancement of information processing technologies, optical disk drives (hereinafter, referred to as “optical disk devices”) that record information in a recording medium like an optical disk become popular. These optical disk devices are built into a recorder, for example, one that records a TV program or a personal computer (PC) with a hard disk drive (HDD), or the like, and are mainly used for recording information like video pictures and images.

Along with improvements in the processing speed of PCs, a high-speed recording process and a reproduction processes of information are in demand for the above-explained optical disk devices. In recent days, various technologies for achieving improvements in information processing speed have been proposed, such as technology for having an optical head stand by at an optimized position after recording information in the recordable optical disk or the reproduction of information recorded in the recordable optical disk is completed, and for enabling the rapid recording or reproduction of information in accordance with the next instruction (see, for example, Patent Literature 1).

An array type disk device or an optical disk library device configured by a plurality of such optical disk devices is known. Such a device operates a combination of a plurality of optical disk devices in order to achieve a memory device having a larger memory capacity, and to achieve a high-speed recording process or reproduction process (see, for example, Patent Literature 2).

Furthermore, recently, a technology for improving the accessing capability of such array type disk devices has been proposed (see, for example, Patent Literature 3).

With regard to the technology disclosed in Patent Literature 3, after using a plurality of optical disk devices and recording or reproducing information, at least one optical disk device unloads an optical disk from an optical disk device, and other optical disk devices store the optical disks as is, to thereby maintain a state that allows for the immediate recording or reproduction of information. Accordingly, the accessing capability of the device is improved.

### PRIOR ART DOCUMENTS

### Patent Literature

Patent Literature 1: Unexamined Japanese Patent Application KOKAI Publication No. 2005-332580
Patent Literature 2: Unexamined Japanese Patent Application KOKA1 Publication No. H11-045497
Patent Literature 3: Unexamined Japanese Patent Application KOKAI Publication No. H08-054991

### SUMMARY OF INVENTION

### Problem to be Solved by the Invention

Conversely, various devices for improving the information processing speed of the solo optical disk device are made so far.

However, even if the improvement of the information processing speed of the solo optical disk device is realized, it is not always true that the processing speed of an array type disk device configured by the plurality of optical disk devices improves as much as it is expected from the improvement of the information processing speed of the solo optical disk device.

For example, each of the plurality of optical disk devices may have a difference in the information processing capability because of an individual difference or a difference in the aging of respective devices even if all devices employ the same configuration. In this case, a time necessary for performing the same process varies among the optical disk devices, and as a result, the optical disk device with a slow processing speed determines the processing speed of the whole device.

Moreover, even if there is no difference in the information processing capability of the device itself among the plurality of optical disk devices, when there is an individual difference in optical disks for recording or reproduction of information, that is, when the decentering level varies among the optical disks or when an optical disk has a unique warpage, at the time of a tracking control or a focus control, the travel distance of the head for recording and reproduction of information varies among the optical disk devices. As a result, there is a difference in the processing speed among the optical disk devices, and the optical disk device with a slow processing speed determines the processing speed of the whole devices.

When it is presumed that the operation of the whole array type disk device includes a plurality of steps: conveying of an optical disk; loading and unloading of an optical disk; and recording or reproduction of information in or from the optical disk, respectively, in order to improve the processing speed of the array type disk device, it is important to individually and cumulatively consider each step. That is, in the case of the array type disk device, it is necessary to not only control the optical disk devices, device by device, configuring the array type disk device, but also control each optical disk device so that the operation of the whole array type disk device is optimized from the standpoint of processing speed. When such a control is not performed, the array type disk device may become awkward to use as a whole.

A first object of the present invention is to provide an array type disk device that is capable of speeding up a process for an optical disk.

A second object of the present invention is to provide a control method for an array type disk device that is capable of speeding up a process for an optical disk.

### Means for Solving the Problem

An array type disk device according to the invention includes: a plurality of optical disk devices, wherein each of the plurality of optical disk devices records and reproduces information in and from an associated recording media; and controller configured to control the each of the plurality of optical disk devices to search for information relating to the associated recording media, respective, when causing the each of the plurality of optical disk devices to execute information processing of the associated recording media, wherein each associated media comprises information of a same volume or a same content, to determine information based on the searched information, and to cause the each of the plurality of optical disk devices to start a next operation based on the determined information.

According to the present invention, a control method for an array type disk device which includes a plurality of optical disk devices and which performs information processing on a plurality of recording media loaded in the plurality of optical disk devices, each optical disk device having a same volume or a same content, the method including; searching for information in each of the plurality of optical disk devices relating to the recording medium loaded in each of the plurality of the optical disk devices, respectively; determining information to be determined information from the searched information; and executing in each of the plurality of optical disk devices a next operation based on determined information.

### Effect of the Invention

Performance of a high-speed recording process and/or a reproduction process of information to a recording medium is possible. Moreover, performance of a precise recording process and/or a reproduction process of information to a recording medium is possible.

### BRIEF DESCRIPTION OF DRAWINGS

FIG. 1 is a block diagram showing an array type disk device according to a first embodiment of the present invention;

FIG. 2 is a plan view showing an optical disk;

FIG. 3 is a conceptual diagram for explaining recording regions of an optical disk;

FIG. 4 is a block diagram showing an optical disk device;

FIG. 5 is a block diagram showing an RF circuit;

FIG. 6 is a block diagram showing a signal quality calculating circuit;

FIG. 7 is a conceptual diagram for explaining how to divide recording data;

FIG. 8 is a conceptual diagram for explaining how to record the divided recording data in a plurality of optical disks;

FIG. 9 is a flowchart showing successive processes executed by the array type disk device according to the first embodiment;

FIG. 10 is a flowchart showing successive processes executed by an array type disk device according to a second embodiment of the present invention;

FIG. 11 is a flowchart showing successive processes executed by an array type disk device according to a third embodiment of the present invention;

FIG. 12 is a diagram for explaining a target position notified to each disk device;

FIG. 13 is a diagram for explaining a determination result by a main control device;

FIG. 14 is a diagram for explaining a modified example of the array type disk device of the third embodiment; and

FIG. 15 is a flowchart showing successive processes executed by an array type disk device according to a fourth embodiment of the present invention.

### BEST MODE FOR CARRYING OUT THE INVENTION

### First Embodiment

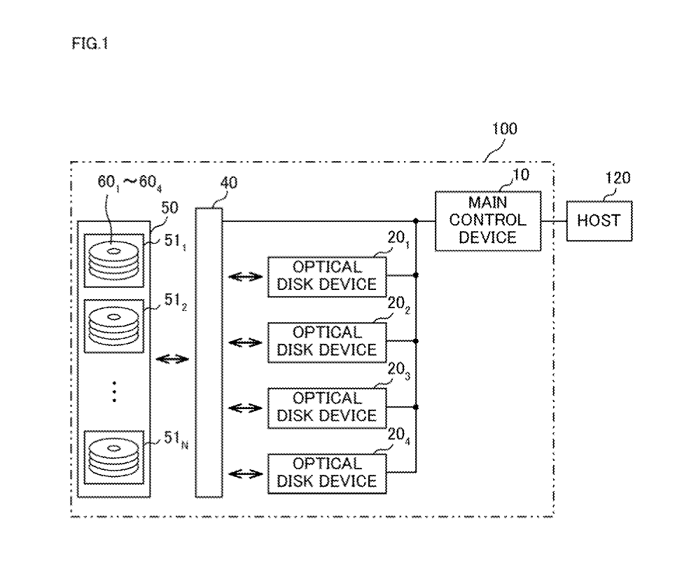

A first embodiment of the present invention will be explained with reference to FIGS. 1 to 9. An array type disk device of the present embodiment determines a beginning address of an un-recorded region notified first from any one of a plurality of optical disk devices configuring the array type disk device as a common writing start address to the plurality of optical disk devices.

FIG. 1 is a diagram showing a general configuration of an array type disk device 100 of the first embodiment. As shown in FIG. 1, the array type disk device 100 includes, for example, optical disk devices 20₁ to 20₄, a holder 50 that retains a plurality of cartridges 51, to 51_{N} loading respective optical disks 60₁ to 60₄, disk convey means (an accessor) 40 that conveys, loads and unloads the optical disks 60₁ to 60₄ between the optical disk devices 20₁ to 20₄ and the holder 50, and a main control device 10 that comprehensively controls the respective units, and is connected to an upper-class device (a host) 120 like a computer through the main control device 10. In the following explanation, when each of the optical disk devices 20₁ to 20₄ and optical disks 60₁ to 60₄ are not uniquely identified, those are comprehensively referred to as an optical disk device 20 and an optical disk 60 in some cases.

The optical disk 60 is, for example, an additionally recordable recording medium, and is a so-called Low-To-High media which increases the reflectivity upon recording.

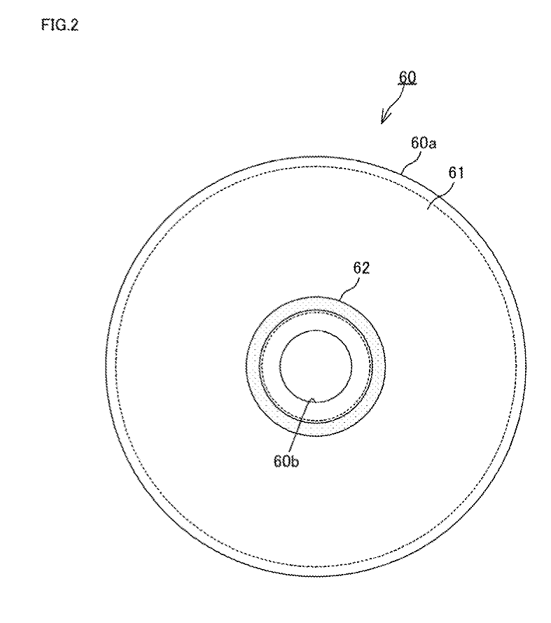

FIG. 2 is a plan view showing the optical disk 60 used for the array type disk device 100. The optical disk 60 has a discoidal and tabular substrate 60a formed of, for example, polycarbonate and having a thickness of 0.6 mm and a diameter of 12 cm. The substrate 60a is provided with a guide groove, a so-called a pre-groove. Moreover, the substrate 60a is provided with a center hole 60b at the center thereof, and a recording layer 61 formed of an organic coloring material.

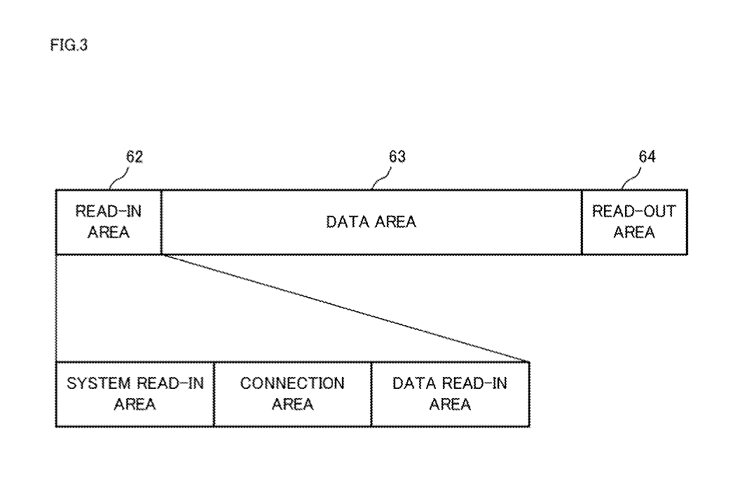

The optical disk 60 has a recordable region where the recording layer 61 is formed. As shown in the conceptual diagram of FIG. 3, this recordable region includes a read-in area 62, a data area 63, and a read-out area 64. As shown in FIG. 2, the read-in area 62 is located in the vicinity of the inner circumference of the recordable region, and includes a system read-in area and a data read-in area. The data area 63 is a region for recording data.

The system read-in area includes a control data zone. The control data zone is a region that records disk production information as system information. The data read-in area is a management information region that records information (disk management information) indicating the recording state of data to the optical disk 60. The disk management information (hereinafter, referred to as management information) includes necessary contents for managing a recording and reproduction process of data, such as up to which address in the data area 63 data is recorded, whether or not additional recording of data is possible, and whether or not recorded data contains only necessary information (for example, whether or not data is recorded with dummy data).

When recording of information on the optical disk 60 or reproduction of information from the optical disk 60 is performed, the beam spot of laser light travels along the guide groove formed in the substrate 60a. Moreover, in the present embodiment, the optical disk 60 employs a physical format that is an in-groove format having a bit pitch of 0.15 μm and a track pitch of 0.40 μm.

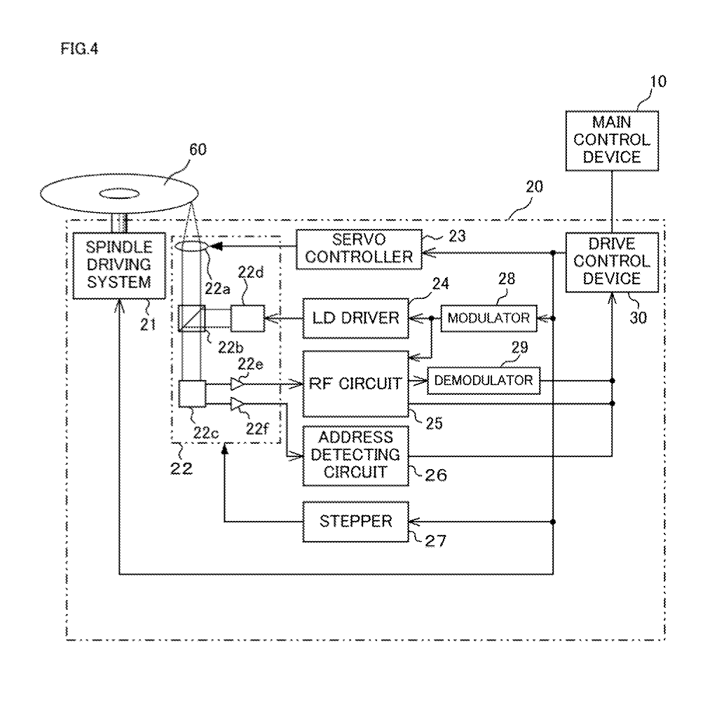

FIG. 4 is a block diagram of an optical disk device 20. As shown in FIG. 4, the optical disk device 20 includes a spindle driving system 21, an optical head 22, a servo controller 23, an LD driver 24, an RF circuit 25, an address detecting circuit 26, a stepper 27, a modulator 28, a demodulator 29, and a drive control device 30.

The spindle driving system 21 causes the optical disk 60 to rotate at a predetermined rotating speed based on an instruction from the drive control device 30.

The optical head 22 irradiates the optical disk 60 with laser light when recording information in the optical disk 60 or when reproducing information from the optical disk 60. As an example, the optical head 22 includes a laser diode 22d that emits laser light with a wavelength of 405 nm or so, an objective lens 22a having a numerical aperture (NA) of 0.65 or so, a beam splitter 22b, an optical receiver 22c, and pre-amplifiers 22e and 22f. The optical head 22 causes the laser diode 22d to emit laser light, the beam splitter 22b to reflect the laser light, and the objective lens 22a to collect light to the recording layer 61 of the optical disk 60. Reflected light from the optical disk 60 enters in the optical receiver 22c through the objective lens 22a and the beam splitter 22b. When receiving laser light reflected from the optical disk 60, the optical receiver 22c outputs a reproduction signal (photoelectric conversion signal) depending on the intensity of the received laser light. The reproduction signal is output to the RF circuit 25 and the address detecting circuit 26, respectively, through respective pre-amplifiers 22e and 22f.

For example, the servo controller 23 drives the objective lens 22a to focus and track laser light coming into the optical disk 60 in accordance with an instruction from the drive control device 30. Hence, the beam spot of laser light is positioned on a desired track on the optical disk 60.

The modulator 28 modulates a recording signal supplied from the drive control device 30, and outputs the modulated signal as a writing signal to the LD driver 24 and the RF circuit 25. Note that a recording signal means a signal that is generated based on information to be recorded in the optical disk 60. Moreover, the writing signal means a signal containing a pattern row used for a recording to the optical disk 60.

The LD driver 24 drives the laser diode 22d based on a writing signal output by the modulator 28. The power of laser light emitted from the laser diode 22d is thus controlled.

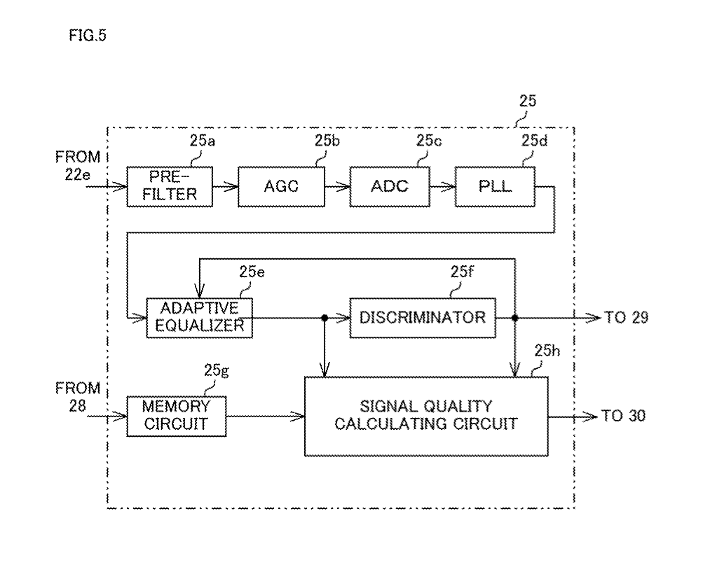

The RF circuit 25 performs a process like filtering on a reproduction signal output by the pre-amplifier 22e of the optical head 22 in order to binarize the signal, and outputs a binary signal to the demodulator 29. Moreover, the RF circuit measures the quality of a reproduction signal, and outputs a signal including the measurement result to the drive control device 30. As shown in the block diagram of FIG. 5, the RF circuit 25 includes a pre-filter 25a, an automatic gain control circuit (AGC) 25b, an A/D converter (ADC) 25c, a phase-locked loop circuit (PLL) 25d, an adaptive equalizer 25e, an discriminator 25f, a memory circuit 25g, and a signal quality calculating circuit 25h, or the like.

A reproduction signal output by the pre-amplifier 22e of the optical head 22 is filtered by the pre-filter 25a, is subjected to an amplitude control by the AGC 25b, and is digitalized by the ADC 25c. The digitalized signal is subjected to extraction of a clock signal by the PLL 25d, is synchronized with a predetermined channel frequency, and is output to the adaptive equalizer 25e.

The adaptive equalizer 25e converts the signal output by the PLL 25d so as to have a characteristic similar to a desired PR (Partial Response) characteristic, and outputs the converted signal as an equalized reproduction signal to the discriminator 25f and the signal quality calculating circuit 25h. The adaptive equalizer 25e includes a finite impulse response (FIR: Finite Impulse Response) filter. The tap coefficient of the FIR filter is adaptively corrected in accordance with a least mean square (LMS: Least Mean Square) algorithm.

The discriminator 25f includes a Viterbi decoder, selects a path having the smallest Euclid distance to an equalized reproduction signal output by the adaptive equalizer 25e, and outputs a sign bit sequence corresponding to the selected path as a binary signal (an estimated pattern sequence). The binary signal is output to the demodulator 29 and the signal quality calculating circuit 25h, and is subjected to a feedback to the adaptive equalizer 25e.

The memory circuit 25g stores a writing signal output by the modulator 28, and outputs the stored writing signal to the signal quality calculating circuit 25h in accordance with an instruction from the drive control device 30.

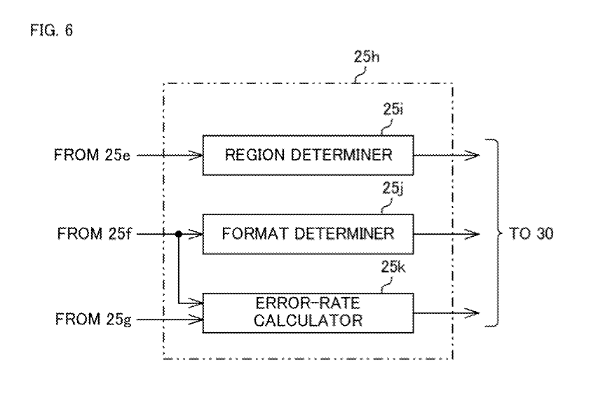

The signal quality calculating circuit 25h calculates and generates information indicating a signal quality based on outputs by the adaptive equalizer 25e and the discriminator 25f and an output by the memory circuit 25g, and outputs such information. As shown in the block diagram of FIG. 6, the signal quality calculating circuit 25h includes a region determiner 25i, a format determiner 25j, and an error-rate calculator 25k.

The region determiner 25i compares the input equalized reproduction signal with a predetermined reference value, and determines whether or not the equalized reproduction signal includes information recorded in the optical disk 60. The region determiner outputs a signal including the determination result to the drive control device 30.

The format determiner 25j determines, using the binary signal, whether or not the signal output by the optical head 22 matches a data format defined-beforehand for each optical disk medium. The format determiner outputs a signal including the determination result to the drive control device 30. The data format defined beforehand is defined by, for example, presence/absence of a VFO region, the number of sectors, a frame interval and the number of frames, the number of sink signals in a sector, the total number of data (in the present example, data field is 77376 bites, 77469 bites in 1ECC block, or the like), the arrangement of data, a data ID, or the like.

The error-rate calculator 25k calculates an error rate as needed based on a writing signal stored in the memory circuit 25g or a binary signal output by the discriminator 25f. The error-rate calculator outputs a signal including the error rate to the drive control device 30.

Returning to FIG. 4, the demodulator 29 performs an error correction process on the binary signal output by the discriminator 25f of the RF circuit 25, and demodulates the corrected binary signal. The demodulator outputs the demodulated signal to the drive control device 30.

The address detecting circuit 26 performs a process like filtering on a reproduction signal output by the optical head 22 in order to detect address information, and outputs the address information to the drive control device 30.

The stepper 27 causes the optical head 22 to perform seeking in accordance with an instruction from the drive control device 30.

The drive control device 30 includes a CPU (Central Processing Unit). The drive control device 30 adjusts parameters mainly related to recording and reproduction of information. Moreover, in accordance with an instruction from the main control device 10 to be discussed later, the drive control device 30 comprehensively controls the whole optical disk devices 20, such as controlling of, relative to the optical disk 60, reproduction of information, recording thereof, and response to various errors when those errors occur. Furthermore, in the present embodiment, the drive control device 30 of each of the optical disk devices 20₁ to 20₄ interrupts the main control device 10, and outputs information including respective states of the optical disk devices 20₁ to 20₄ as needed.

As an example, the above-explained optical disk device 20 records information on the optical disk 60 and reads (reproduces) information from the optical disk 60 in a unit of 1 ECC (Error Correcting Code) block of 64 KB. Moreover, according to the format definition of the optical disk 60 of the present embodiment, for example, 1ECC block includes a VFO field, a data field, a post-amble field, a buffer field, and the like. Furthermore, the data field includes 32 sectors, and a sector includes 26 frames. Each sector includes a data ID (identifier) including a frame number, and the ID is simultaneously recorded when information (data) is recorded.

Moreover, the optical disk device 20 performs recording on the optical disk 60 using a modulation code which is so-called an ETM (8/12 modulation: Eight to Twelve Modulation). ETM has the shortest mark or shortest space which is 2 T (where T is a channel clock frequency) and is a type of (1-7) RLL coding (Run Length Limited Coding). When an input data sequence is a sequence of bit information of 1 and 0, a sequence of the same bit information is referred to as run (Run). (1-7) RLL coding is a modulation rule having the minimum run of 1 and the longest run of 7. According to the (1-7) RLL coding, the minimum mark or the minimum space becomes 2 T. Moreover, the longest mark or the longest space becomes 8 T.

Returning to FIG. 1, the holder 50 detachably retains the plurality of cartridges 51₁ to 51_{N} each of which holds, for example, four optical disks 60.

The accessor 40 takes out any one cartridge 51 from the holder 50 in accordance with an instruction from the main control device 10, and loads the four optical disks 60₁ to 60₄ held in the taken cartridge 51 into the optical disk devices 20₁ to 20₄, respectively. Moreover, the accessor 40 unloads the optical disks 60₁ to 60₄ to which a process like reproduction of information or recording thereof has been performed by the optical disk devices 20₁ to 20₄, respectively, retains the disks in the cartridge 51, and retains this cartridge 51 in the holder 50.

The main control device 10 includes a CPU, a ROM (Read-Only Memory) that stores a program run by the CPU, a RAM (Random Access Memory) that serves as a work area for the CPU, and the like.

When information to be recorded (hereinafter, referred to as recording data) is supplied from the host 120, the main control device 10 divides the recording data, and dividingly outputs the recording data to respective optical disk devices 20₁ to 20₄. Moreover, in response to a request from the host 120, the main control device 10 combines data output by respective optical disk devices 20₁ to 20₄ (hereinafter, referred to as reproduction data) and outputs the combined data to the host 120.

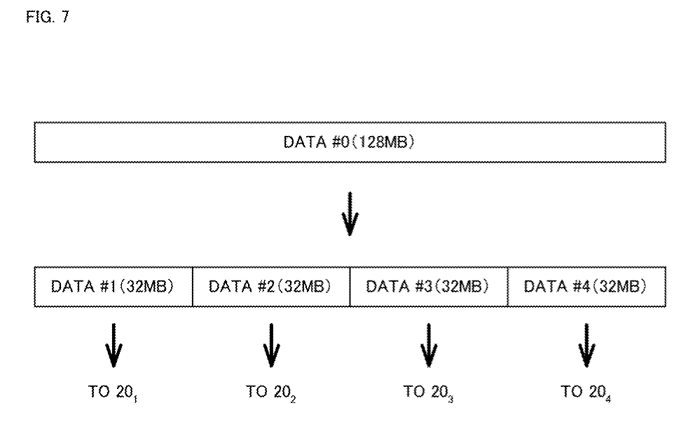

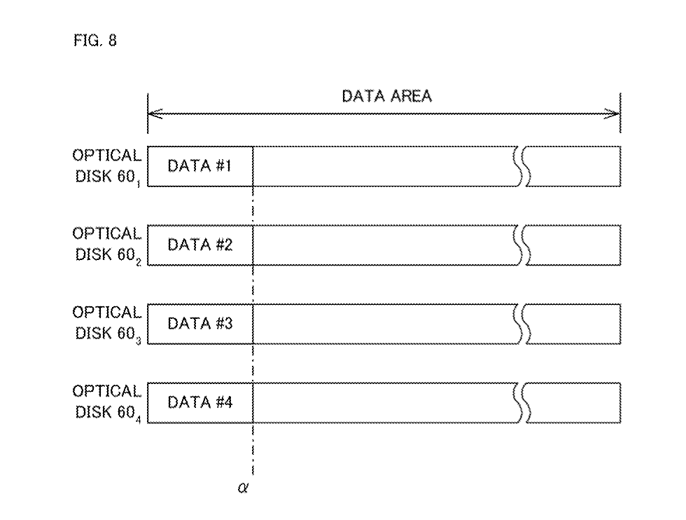

FIG. 7 is a conceptual diagram for explaining how recording data is divided by the main control device 10. For example, when data #0 with a volume of 128 MB is supplied from the host 120, as shown in FIG. 7, the main control device 10 divides the data #0 into four data #1 to #4 each having a volume of 32 MB, and outputs the data #1 to #4 to respective optical disk devices 20₁ to 20₄. Accordingly, respective optical disk devices 20, to 20₄ substantially simultaneously start recording data #1 to #4, and as shown in the conceptual diagram of FIG. 8, respective data #1 to #4 are recorded in respective data areas 63 of the optical disks 60₁ to 60₄ loaded in the optical disk devices 20₁ to 20₄ up to an address α. Moreover, when recording of data #1 to #4, respective drive control devices 30 of the optical disk devices 20₁ to 20₄ record, as management information, information including information up to where recording in the data area 63 and information on the address a of each of the data #1 to #4 in the data read-in area of the optical disks 60.

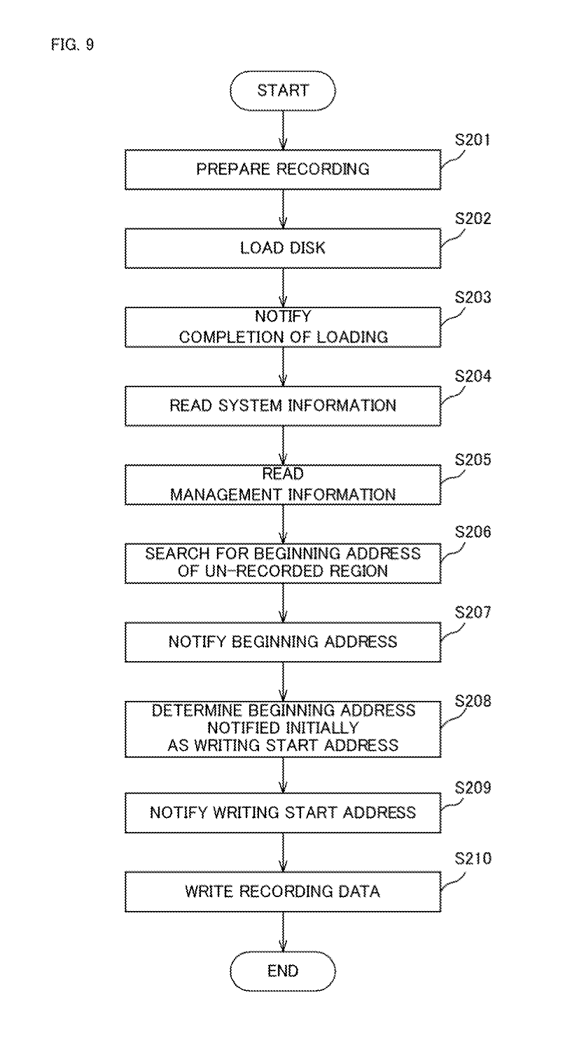

FIG. 9 is a flowchart showing successive processes executed by the array type disk device 100 when receiving information to be recorded in an optical disk (recording information) from the host 120. Hereinafter, the operation of the array type disk device 100 will be explained with reference to FIG. 9. As shown in FIG. 8, the optical disks 60₁ to 60₄ are presumed to be loaded in respective optical disk devices 20₁ to 20₄ and record data up to the address a of the data area 63. The divided (recording) data are required to have the same volume for each of a plurality of volumes, but are not required to have consistency of contents for each of the plurality of volumes.

When recording information to be recorded in the optical disks 60 is supplied from the host 120, the main control device 10 outputs an instruction to optical disk devices 20₁ to 20₄ and the accessor 40 to prepare starting a recording (step S201). In response to this instruction, the accessor 40 conveys the optical disks 60₁ to 60₄ from a predetermined cartridge 51, (where 1≦i≦N) in the holder 50, and loads the optical disks 60₁ to 60₄ in respective optical disk devices 20₁ to 20₄ (step S202). Moreover, when the optical disks 60₁ to 60₄ are loaded in respective optical disk devices 20₁ to 20₄, respective drive control devices 30 of the optical disk devices 20₁ to 20₄ notify the main control device 10 of completion of the loading of the optical disks 60₁ to 60₄ (step S203).

Next, respective drive control devices 30 of the optical disk devices 20₁ to 20₄ execute reading of system information recorded in respective optical disks 60₁ to 60₄ loaded in respective optical disk devices (step S204). In this process, respective drive control devices 30 of the optical disk devices 20₁ to 20₄ drive respective steppers 27, thereby moving respective optical heads 22 to positions corresponding to the system read-in areas of respective optical disks 60₁ to 60₄. Next, disk production information are obtained from respective optical disks 60₁ to 60₄, and based on this information, information on the loaded optical disks 60₁ to 60₄, that is, the type of a disk and information on a manufacturer company is obtained. Based on the obtained system information, the drive control device 30 determines that, for example, the loaded optical disk is an additionally recordable optical disk which meets a standard A, and is a Low-To-High type medium where the recording mark has a higher reflectivity than that of the un-recorded region. Moreover control method, the drive control device 30 specifies the company name based on information on the manufacturer, and generates a parameter table relating to the medium. Generation of the parameter table is carried out based on the system information recorded in the optical disk.

The optical disk device 20 may store, for example, a plurality of parameter tables beforehand, and the drive control device 30 may select any one of the parameter tables in accordance with the type of loaded optical disk. Moreover, when the type of an optical disk to be loaded is limited beforehand, the process of determining the type of the optical disk and the process of specifying the manufacturer of the optical disk may be skipped. Furthermore, the process of determining the type of the optical disk and the process of specifying the manufacturer of the optical disk may be executed by the main control device 10. In this case, it is necessary for the drive control device 30 to output system information obtained from the optical disk device 20 to the main control device 10.

Next, respective drive control devices 30 of the optical disk devices 20₁ to 20₄ execute reading of the management information of respective optical disks 60₁ to 60₄ (step S205). In the present embodiment, reading of the management information is autonomously executed by the drive control devices 30 of respective optical disk devices 20₁ to 20₄, and not by an instruction from the main control device 10. As explained above, data are recorded in respective data areas 63 of the optical disks 60₁ to 60₄ loaded in respective optical disk devices 20₁ to 20₄ up to the address α. Hence, management information with the same contents are read from the optical disks 60₁ to 60₄, respectively. If management information different from other information are read from at least one of the optical disks 60₁ to 60₄, it is possible to determine that this optical disk has an abnormality.

Moreover, the management information may be stored in a memory device other than the optical disk. In this case, the main control device 10 or the drive control device 30 may read the management information from the memory device. Furthermore, instead of autonomous reading, the main control device 10 or the drive control device 30 may instruct a device having the memory device to transmit the management information. An example of such a recording device is a device including a non-volatile memory, or a hard disk drive.

Next, the drive control device 30 executes searching for a beginning position of a region where information can be additionally recorded in the data area 63 (step S206). In this process, the drive control device 30 detects the end address of the region where information is recorded, based on the read management information. Next, the optical head 22 is caused to perform seeking around the position corresponding to this address (hereinafter, referred to as a target position). This seeking is carried out by causing the optical head 22 to pass through the target position along the guide groove of the optical disk.

More specifically, the drive control device 30 roughly moves the optical head 22 to the target position by driving the stepper 27 having the driving position calibrated beforehand. Next, the address of the actual position (the current position) of the optical head 22 relative to the optical disk 60 is detected based on an output signal by the address detecting circuit 26. When the current position is far from the target position on some level, the optical head 22 is roughly moved based on the difference between the current position and the target position. Moreover, when the current position and the target position are close to each other, the optical head 22 is precisely moved. When the optical head 22 is precisely moved, for example, the drive control device 30 moves the optical head 22 while counting the number of traverses of the grooves formed in the optical disk 60. While the optical head 22 approaches the target position when precisely moving, the optical head 22 is positioned for each track on the tracks. Through the foregoing operation, the optical head 22 can be quickly moved to the vicinity of the target position.

Eventually, by causing the optical head 22 to perform tracing along the guide groove, the beginning position of the un-recorded region of the optical disk 60 is detected. The region determiner 25i is used for this detection. In the present embodiment, the tracing is started from the position of at least 4ECC blocks ahead of the address of the target position. How to move the optical head 22 as explained above is just an example, and other schemes may be employed.

The drive control device 30 always monitors an output signal by, for example, the region determiner 25i configuring the signal quality calculating circuit 25h shown in FIG. 6 while causing the optical head 22 to perform seeking, and based on this output signal, specifies, as the beginning address of the un-recorded region, the address of a boundary between the region (recorded region) where information is recorded and the region (un-recorded region) where no information is recorded in the optical disk 60. Next, the drive control device 30 notifies the main control device 10 of the specified beginning address (step S207).

When the beginning address is specified as explained above, for example, a verify operation may be performed which checks again that the specified beginning address corresponds to the boundary between the recorded region and the un-recorded region. In this case, the same operation including the seeking operation is repeated, thereby permitting the beginning address of the un-recorded region to be more precisely specified.

The processes from the step S203 to the step S207 are executed by all of the optical disk devices 20₁ to 20₄. When receiving the notification of the beginning address first from any one of the optical disk devices 20₁ to 20₄, the main control device 10 determines the beginning address notified first as the writing start address of the optical disks 60 loaded in all optical disk devices 20, to 20₄ without waiting for notifications of respective beginning addresses from the other optical disk devices 20 (step S208). The main control device 10 notifies optical disk devices 20₁ to 20₄ of this writing start address (step S209). While at the same time, the main control device 10 divides recording data supplied from the host 120, and outputs the divided recording data into respective optical disk devices 20₁ to 20₄.

Each of the optical disk devices 20₁ to 20₄ executes writing of the divided recording data from the notified writing start address (step S210). Next, upon completion of the writing of the recording data, the successive processes by the array type disk device 100 complete.

As explained above, according to the present embodiment, when any one of the plurality of optical disk devices 20 notifies the main control device 10 of a beginning address first, the main control device 10 determines this beginning address notified first as a writing start address without waiting for notifications of respective beginning addresses from the other optical disk devices 20. Next, the main control device 10 notifies each optical disk device 20 of the determined writing start address. Accordingly, even if there is a difference in the processing speed among the optical disk devices 20 and thus the searching time for a writing start address differs, all optical disk devices 20 start writing of information like the optical disk device 20 which is first to complete the searching for the beginning address. Hence, the high-speed writing can be realized as the whole array type disk device 100.

### Second Embodiment

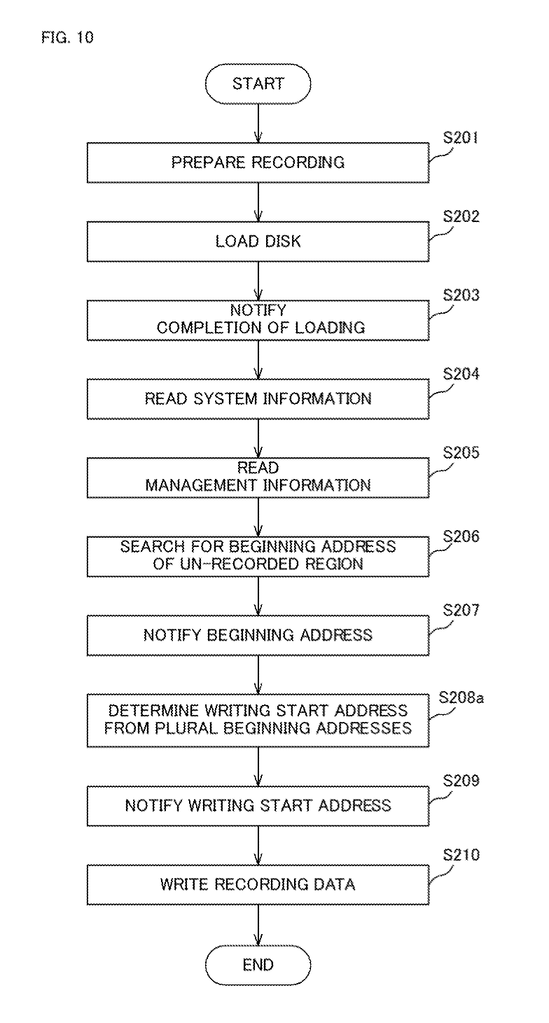

Next, an explanation will be given of a second embodiment of the present invention with reference to FIG. 10. An array type disk device 100 of the present embodiment differs from the array type disk device 100 of the first embodiment in that a writing start address is determined based on a plurality of notified beginning addresses. The details of the second embodiment will be explained below. The explanation for the same component as that of the first embodiment or the equivalent thereto will be omitted or simplified in the present embodiment.

The array type disk device 100 of the present embodiment has the equivalent hardware configuration to that of the array type disk device 100 of the first embodiment.

FIG. 10 is a flowchart showing successive processes executed by the array type disk device 100 of the second embodiment. According to the array type disk device 100 of the present embodiment, after the processes from a step S201 to a step S207 complete, the main control device 10 determines a writing start address based on a plurality of notified beginning addresses (step S208a). The contents of the step S208a will be explained in more detail below.

When receiving a notification of a beginning address first from any one of the optical disk devices 20₁ to 20₄, and receiving another notification of a beginning address from another optical disk device 20, the main control device 10 compares the two beginning addresses with each other. When the compared beginning addresses are consistent with each other, the main control device determines a writing start address based on those beginning addresses.

Conversely, when those two beginning addresses differ from each other, every time the third or following beginning address is notified, the main control device 10 compares the newly notified beginning address with the already-notified beginning addresses, and determines the newly notified beginning address as a writing start address based on a majority theory when the newly notified beginning address is consistent with any one of the already-notified beginning addresses. Hence, in comparison with a case in which a beginning address notified first is determined as a writing start address, the reliability of the determined location of the writing start address is improved.

When the newly notified beginning address is consistent with any one of the already-notified beginning addresses, the optical disk devices 20 may be caused to further search for a beginning address, and when at least equal to or greater than three beginning addresses notified are consistent one another, such an address may be determined as a writing start address. In this case, in comparison with a case in which a writing start address is determined based on the two beginning addresses, the reliability of the determined location of the writing start address is further improved.

As explained above, when the writing start address is determined in the step S208a, the main control device 10 notifies optical disk devices 20₁ to 20₄ of the writing start address (step S209). While at the same time, the main control device divides recording data from the host 120, and outputs divided recording data to optical disk devices 20₁ to 20₄, respectively.

Respective optical disk devices 20₁ to 20₄ execute writing of the divided recording data from the notified writing start address (step S210). Upon completion of the writing of the recording data, the successive processes by the array type disk device 100 are completed.

As explained above, according to the second embodiment, based on the plurality of beginning addresses notified from the optical disk devices 20₁ to 20₄, the writing start address is determined. Hence, in comparison with a case in which a beginning address notified first is determined as a writing start address, the reliability of the determined location of the writing start address is improved, and the possibility where a false address is determined as a writing start address is reduced.

When all of the beginning addresses notified from respective optical disk devices 20₁ to 20₄ differ from one another, the main control device 10 returns the process to the step S206, and repeats the processes from the step S206 to the step S208a until a writing start address is determined.

In this case, each drive control device 30 of the optical disk devices 20₁ to 20₄ may specify a beginning address based on an output signal by, for example, the format determiner 25j instead of specifying a beginning address based on an output signal by the region determiner 25i.

Moreover, a beginning address may be determined based on both output signal by the region determiner 25i and output signal by the format determiner 25j.

When the processes from the step S206 to the step S208a are repeated, information from each of the same optical disk devices 20₁ to 20₄ may be treated as information with mutually different contents. In this case, information may be managed as #1DATA, #2DATA, . . . , #nDATA in accordance with an order of a notification to the main control device 10.

For example, when the array type disk device 100 includes only two devices: an optical disk device #1; and an optical disk device #2, it can be configured such that the third information is re-notified information by either one of the optical disk devices.

When information notified from respective optical disk devices 20 to the main control device 10 are not consistent one another within a predetermined number of notifications of a beginning address or within a predetermined time, the main control device 10 may determine that the optical disk 60 is defective and may terminate all processes. In this case, the main control device may notify the host 120 of the defect of the optical disk 60.

Unlike hard disks, optical disks are used under a situation in which a recording surface is not sealed. Hence, dirt or dusts may adhere to the recording surface or a scratch may be formed thereon. Adhesion of the dirt, or the like, to the recording surface affects reflective light from the optical disk, and due to this effect, a false address may be specified in the above-explained searching for the beginning address. According to the second embodiment, however, since the plurality of beginning addresses are compared and a writing start address is determined, recording error due to a false recognition of the writing start address for information can be effectively reduced.

### Third Embodiment

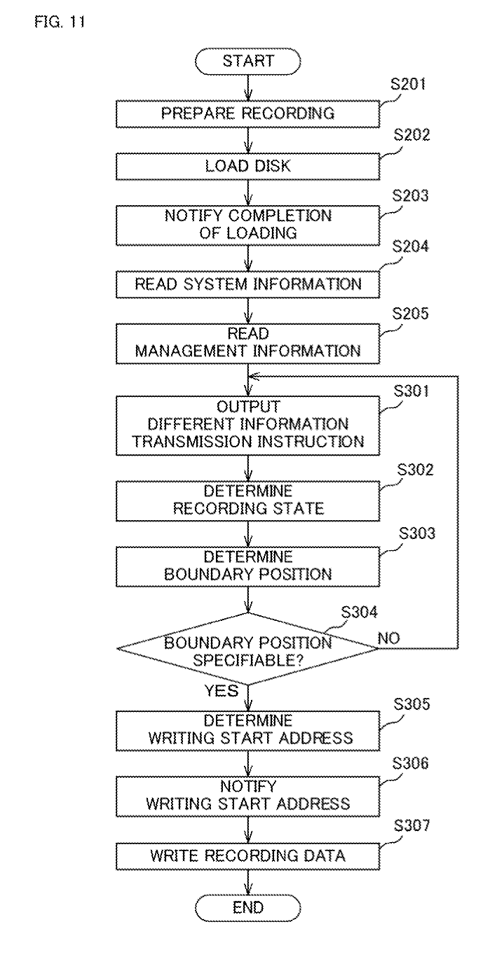

Next, an explanation will be given of a third embodiment of the present invention with reference to FIG. 11. An array type disk device 100 of the present embodiment determines a writing start address based on different information when different information can be obtained from respective optical disk devices 20₁ to 20₄. The details of the third embodiment will be explained below. The explanation for the same component as that of the first embodiment or the equivalent thereto will be omitted or simplified in the present embodiment.

The array type disk device 100 of the present embodiment has the equivalent hardware configuration to that of the array type disk device 100 of the first embodiment.

FIG. 11 is a flowchart showing successive processes executed by the array type disk device 100 of the third embodiment. According to the array type disk device 100 of the present embodiment, processes following a step S301 are successively executed after the processes from the step S201 to the step S205 explained in the first embodiment are executed.

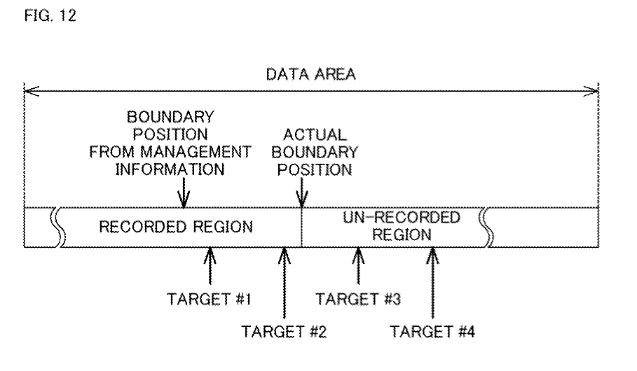

The main control device 10 outputs target positions which differ among the optical disk devices 20₁ to 20₄ to the optical disk devices 20₁ to 20₄, respectively (step S301). As an example, target positions #1, #2, #3, and #4 are notified to the optical disk devices 20₁, 20₂, 20₃, and 20₄, respectively. FIG. 12 shows target positions #1 to #4 notified to respective optical disk devices 20₁ to 20₄. As shown in FIG. 12, the target positions #1 to #4 are set so that adjoining target positions are apart from each other by a predetermined address.

More specifically, the target position #1 that is the origin of the target positions #1 to #4 is set to a location offset from a writing start position by a predetermined amount based on management information. The remaining target positions #2 to #4 are successively set so that the target position #3 for example is located at an un-recorded region side relative to the writing start position based on the management information.

When notified of the target positions #1 to #4 from the main control device 10, respectively, the drive control devices 30 of respective optical disk devices 20₁ to 20₄ execute tracing in the vicinity of the respective notified target positions along the guide groove. The drive control device 30 determines whether or not the traced position includes a recorded region, and notifies the main control device 10 of the determination result (step S302).

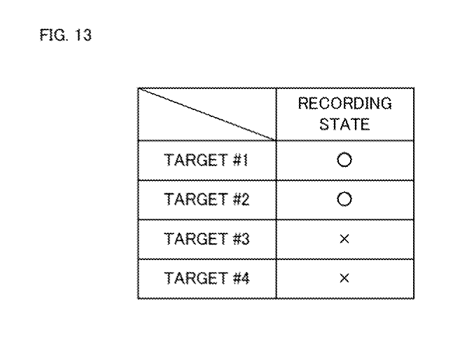

For example, as shown in FIG. 12, when the target positions #1 to #4 are set, the optical disk device 20₁ that has traced the vicinity of the target position #1 determines that there is a recorded region, and notifies the main control device 10 of this determination result. Moreover, the optical disk devices 20₂, 20₃ and 20₄ that have traced respective vicinities of the target positions #2, #3, and #4 also determine the presence/absence of the recorded region and notify the main control device 10 of the determination results, respectively. As a result, as shown in the table in FIG. 13, the main control device 10 determines that the target position #1 and the target position #2 belong to a recorded region, and the target position #3 and the target position #4 belong to an un-recorded region. In the table shown in FIG. 13, a circular mark indicates that it belongs to the recorded region and a cross mark indicates that it belongs to the un-recorded region.

Next, the main control device 10 determines an actual boundary position between the recorded region and the un-recorded region based on the notified determination results from respective optical disk devices 20₁ to 20₄ (step S303). In this example, the main control device 10 determines that an actual boundary position is present between the target position #2 and the target position #3.

Next, the main control device 10 determines whether or not it is possible to specify the actual boundary position between the recorded region and the un-recorded region based on the determination result in the step S303 (step S304). The optical disk 60 has a unit of recording of data of 1ECC, which has a size of 0x20. Hence, when the difference between consecutive addresses of two target positions that confine the actual boundary position between the recorded region and the un-recorded region is 1ECC, the main control device 10 determines that specifying of the boundary position at those target positions is possible. When the difference is larger than 1ECC, the main control device 10 determines that specifying of the boundary position is not possible.

More specifically, for example, when the address of the target position #2 belonging to the recorded region is 0x450000, and the address of the target position #3 belonging to the un-recorded region is 0x450020, the main control device 10 determines that the boundary between the recorded region and the un-recorded region is present between the address 0x450000 and the address 0x450020. Moreover, the main control device 10 specifies that the beginning address of the un-recorded region is 0x450020.

Conversely, when the address of the target position #2 is, for example, 0x450000 and the address of the target position #3 is 0x452000, unambiguously specifying the address of the boundary between the recorded region and the un-recorded region is difficult (step S304: NO). In this case, the main control device 10 returns the process to the step S301, and outputs different target positions from the optical disk devices 20₁ to 20₄ to respective optical disk devices 20₁ to 20₄ (step S301). In this case, the target positions #1 to #4 are set based on the determination result in the step S303. For example, as shown in FIG. 12, when the main control device 10 determines that an actual boundary position between the recorded region and the un-recorded region is present between the target position #2 and the target position #3, as an example, respective positions of the target positions #1 to #4 are set again so that the original target position #2 becomes a target position #1, and the original target position #3 becomes a target position #4.

Hereinafter, the processes from the step S301 to the step S304 are repeated until the main control device 10 determines in the step S304 that specifying of the boundary position is possible.

When the main control device 10 determines that all target positions are the recorded regions, for example, the interval between the target positions is set to remain the same, and the whole target positions are shifted so that the target position #1 becomes the original target position #4.

When the main control device 10 determines that all target positions are un-recorded regions, for example, the interval between the target positions is set to remain the same, and the whole target positions are shifted so that the target position #4 becomes the original target position #1.

The processes from the step S301 to the step S304 are repeated in this fashion until the recorded region and the un-recorded region change at any one position from the target position #1 to the target position #4.

As another scheme, the target position #1 or the target position #4 may be fixed, the interval between the target positions may be increased, and the processes from the step S301 to the step S304 may be repeated until the recorded region and the un-recorded region change at any one position from the target position #1 to the target position #4.

The processes thereafter are similar to a case in which the boundary between the recorded region and the un-recorded region is present between the target position #2 and the target position #3.

When the main control device 10 determines in the step S304 that the boundary position can be specified (step S304: YES), the main control device 10 determines the next address to the actual boundary position between the recorded region and the un-recorded region, that is, the beginning address of the un-recorded region as a writing start address (step S305), and notifies the optical disk devices 20₁ to 20₄ of the determined writing start address (step S306). While at the same time, the main control device 10 divides recording data from the host 120, and outputs the divided recording data to respective optical disk devices 20₁ to 20₄.

Respective optical disk devices 20₁ to 20₄ execute writing of divided recording data from the notified writing start address (step S307). Upon completion of the writing of the recording data, the successive processes by the array type disk device 100 complete.

As explained above, according to the present embodiment, the main control device 10 notifies the optical disk devices 20₁ to 20₄ of different target positions, respectively. Respective optical disk devices 20₁ to 20₄ simultaneously perform tracing relative to respectively notified target positions (address positions) among the four target positions. By causing the plurality of optical disk devices 20 to share the tracing operation, tracing for a wide range can be executed within a short time, and as a result, the actual boundary position between the recorded region and the un-recorded region of the optical disk 60 can be quickly detected. As a result, the additional writing operation to the optical disk can be started rapidly.

This is especially effective when the target position (in the present embodiment, the target position #1) and the true boundary position are distant from each other because the boundary position determined based on management information and the actual boundary position are largely distant from each other, or when the searching range is wide. Moreover, the method explained in the present embodiment is especially effective when the difference in the performance among the optical disk devices is small or when the varying of the performance of the optical disk media is little.

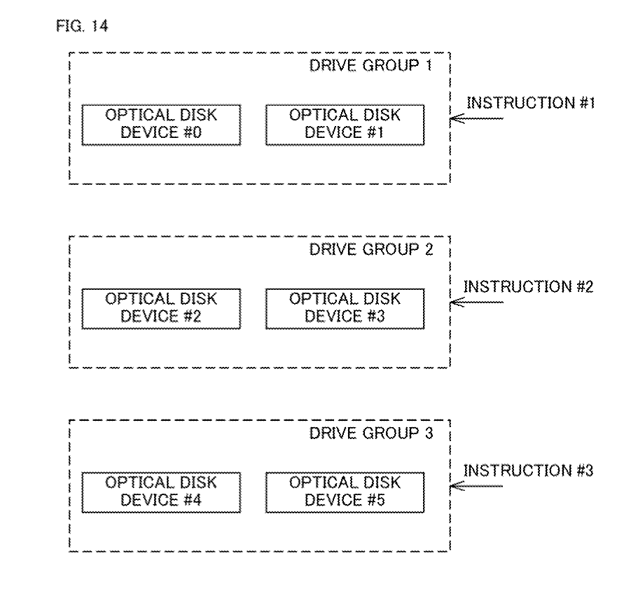

Moreover, as shown in FIG. 14, a plurality of optical disk devices may be defined as a drive group, the main control device 10 may output different target positions to the drive groups, respectively, and may obtain different information depending on the drive group while improving the accuracy of information obtained from each drive group. Hence, rapidly and precisely searching for the actual boundary position between the recorded region and the un-recorded region becomes possible. The target position at this time may differ depending on the drive group or at least some of the target positions may be consistent one another.

### Fourth Embodiment

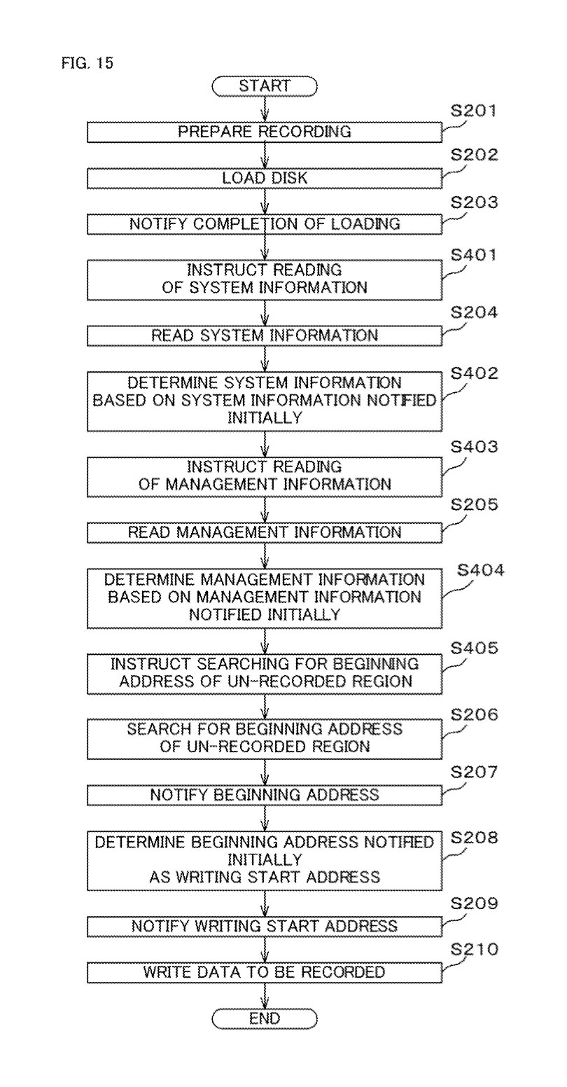

Next, an explanation will be given of a fourth embodiment of the present invention with reference to FIG. 15. An array type disk device 100 of the present embodiment determines the state of the system, or the like, based on system information or management information notified first. The details of the fourth embodiment will be explained below. The explanation for the same component as that of the first embodiment or the equivalent thereto will be omitted and/or simplified in the present embodiment.

The array type disk device 100 of the present embodiment has the equivalent hardware configuration to that of the array type disk device 100 of the first embodiment.

FIG. 15 is a flowchart showing successive processes executed by the array type disk device 100 of the fourth embodiment. According to the array type disk device 100 of the present embodiment, after the processes from the step S201 to the step S203 complete, the main control device 10 instructs optical disk devices 20, to 20₄ to read system information, respectively (step S401).

Respective drive control devices 30 of the optical disk devices 20, to 20₄ execute reading of system information from respective loaded optical disks 60, to 60₄ upon receiving the instruction from the main control device 10 of reading the system information, and notify the main control device 10 of respective reading results (step S204).

At the time of giving an instruction of reading the system information, the main control device 10 notifies respective drive control devices 30 as a target address of an address where the system information is recorded. Respective optical disk devices 20, to 20₄ search, through respective drive control devices 30 which have received the notification, for corresponding information in the vicinity of the notified address, and perform reading.

When receiving a notification of system information from any one of the optical disk devices 20, to 20₄, the main control device 10 uses the system information notified first as the system information for respective optical disk devices 20, to 20₄ (step S402). Next, the main control device 10 instructs respective optical disk devices 20, to 20₄ to read management information (step S403).

Upon receiving the instruction from the main control device 10 of reading the management information, respective drive control devices 30 of the optical disk devices 20, to 20₄ execute reading of management information from respective loaded optical disks 60₁ to 60₄, and notify the main control device 10 of the reading results (step S205).

At the time of giving the instruction of reading the management information, the main control device 10 notifies respective drive control devices 30 as a target address of an address where the management information is recorded. Respective optical disk devices 20, to 20₄ search, through respective drive control devices 30 which have received the notification, for corresponding information in the vicinity of the notified address, and perform reading.

When receiving a notification of management information from any one of the optical disk devices 20₁ to 20₄, the main control device 10 uses the management information notified first as the management information for optical disk devices 20, to 20₄ (step S404). Next, the main control device 10 instructs respective optical disk devices 20, to 20₄ to search for the beginning addresses of un-recorded regions (step S405).

Thereafter, the processes from the step S206 to the step S210 explained in the first embodiment are successively executed.

The main control device 10 instructs reading of the management information in the step S403. The main control device 10 may notify respective optical disk devices 20, to 20₄ of respective target addresses relating to the reading of the management information in order to cause the optical disk devices 20₁ to 20₄ to perform distributed searching, and different regions on the optical disks 60 specified by individual target addresses may be searched for, respectively. The main control device 10 may decide a next operation (for example, reading of the management information and searching for the beginning address) based on the management information notified first.

Moreover, when system or management information from the plurality of optical disk devices 20₁ to 20₄ are consistent among at least some optical disk devices 20, the main control device 10 may output a next instruction based on such consistent information.

### Fifth Embodiment

Next, an explanation will be given of a fifth embodiment of the present invention. The explanation for the same components as that of the fourth embodiment or the equivalent thereto will be omitted and/or simplified in the present embodiment.

An array type disk device 100 of the present embodiment differs from the array type disk device 100 of the fourth embodiment in that the main control device 10 gives an instruction to respective optical disk devices 20₁ to 20₄ based on information notified from respective optical disk devices 20₁ to 20₄ which autonomously operate. Upon obtaining of management information notified first among the management information notified by the optical disk devices 20₁ to 20₄, the main control device 10 determines that management information which can be obtained from other optical disk devices 20 are obtained. Next, using this information, the main control device 10 gives an instruction to respective optical disk devices 20₁ to 20₄ to execute the next operation. That is, according to the array type disk device 100 of the present embodiment, respective optical disk devices 20₁ to 20₄ autonomously operate, so that the step S401 that is an instruction of reading system information, the step S403 that is an instruction of reading management information and the step S405 that is an instruction of searching for the beginning address of the un-recorded region are eliminated all of which are given from the main control device 10 to respective optical disk devices 20₁ to 20₄.

As explained above, according to the array type disk device 100 of the present embodiment, respective optical disk devices 20₁ to 20₄ autonomously operate. Hence, without giving an instruction of, for example, reading of management information ect. to respective optical disk devices 20₁ to 20₄, the main control device 10 determines the recording state of the optical disk 60 and the state of each device upon obtaining of desired information notified from any one of the optical disk devices 20₁ to 20₄, and gives an instruction for the next operation. Thus, according to the present invention, the process load of the main control device 10 is reduced, and the performance of the whole array type disk device 100 is improved. Moreover, according to the array type disk device 100 of the present embodiment, since the load is distributed, it is possible to cope with further various operations. In the present embodiment, like the second embodiment, the main control device 10 may determine that reading of management information completes when information from respective optical disk devices 20₁ to 20₄ are consistent among at least some optical disk devices 20.

In the above-explained respective embodiments, the explanation was given of a case in which data is recorded beforehand in the optical disk 60, but the present invention is not limited to this case, and can be applied to a case in which recording and reproduction of information are performed on a new optical disk which records no data. In this case, the present invention is applied to the operation relating to the reproduction of system information and management information. For example, when no management information is recorded, the main control device 10 determines this state, and then outputs an instruction for the next operation. Examples of contents of the instruction for the next operation are recording of data and a calibration operation of correcting the state of the optical disk device.

In the above-explained respective embodiments, the region determiner 25i is used for a determination of a region where data is recorded and a region where no data is recorded, but the format determiner 25j may be used, or both region determiner 25i and format determiner 25j may be used for this purpose. In the latter case, in comparison with a case in which only the region determiner 25i performs determination, the determination precision improves.

In the above-explained respective embodiments, the explanation was given of a case in which data are recorded in the optical disks 60 loaded in respective optical disk devices 20₁ to 20₄ up to the same address. However, the recording of data may not be completed up to the same address, such as, when a power supply, for example, is abruptly terminated because of a sudden disaster, or the like.

The array type disk devices 100 of the above-explained respective embodiments are based on a presumption that the same volume of data is recorded in each of the optical disks 60 loaded in respective optical disk devices 20₁ to 20₄. Hence, when the volume of data recorded in respective optical disks 60 is different among each other, it is inappropriate if the beginning position of the region where information is additionally recorded is searched for through the method explained in the above-explained embodiments. In this case, the main control device 10 may notify an upper-class host of the abnormality of the device. Moreover, the abnormality of the device may be indicated by ejecting the optical disk 60.

Moreover, in the above-explained embodiments, the explanation was given of a case in which system information, management information, or the like, are individually notified to the main control device 10, but the present invention is not limited to this case, and information may be notified to the main control device 10 at the same time. In this case, the main control device 10 may re-construct base data using those information, distribute the base data and cause respective optical disk devices 20₁ to 20₄ to keep recording.

In the above-explained embodiments, the explanation was given of a case in which data is additionally recorded, but the same effect can be obtained if the first, second, fourth and fifth embodiments are applied to a case in which data is reproduced. In this case, a reproduction start address is determined based on an output by the address detecting circuit 26, and regarding FIGS. 9 and 10 for example, “search for beginning address of un-recorded region” in the step S206, “writing start address” in the steps S208 (or the step S208a) and S209, and “write recording data” in the step S210 are respectively changed to “search for beginning address subjected to reproduction”, “reproduction start address”, and “reproduce recording data”. Moreover, regarding FIG. 15, “instruct searching for beginning address of un-recorded region” in the step S405, “search for beginning address of un-recorded region” in the step S206, “writing start address” in the steps S208 and S209, and “write recording data” in the step S210 are respectively changed to “instruct searching for beginning address subjected to reproduction”, “search for beginning address subjected to reproduction”, “reproduction start address”, and “reproduce recording data”. Hence, as explained in the above-explained respective embodiments, also at the time of reproduction of data, the high-speed reproduction process can be realized, and the reliability of the reproduction process is improved.

Moreover, in the above-explained embodiments, as an example, the optical head 22 includes the laser diode 22d that emits laser light with a wavelength of 405 nm or so and the objective lens 22a with the numerical aperture (NA) of 0.65 or so, but the present invention is not limited to this configuration. The optical head 22 may be configured by a laser diode 22d with another wavelength and an objective lens 22a with another numerical aperture.

Moreover, in the above-explained embodiments, the explanation was given of a case in which the optical disk 60 is a Low-To-High type additionally recordable medium, but the present invention is not limited to this case. The optical disk 60 may be a medium which is so-called a High-To-Low type that reduces the reflectivity than that of the un-recorded region when recoding information. Moreover, the optical disk 60 may be a rewritable recording medium.

The optical disk 60 has a substrate whose thickness is 0.6 mm or so, but the present invention is not limited to this configuration, and for example, the medium may have a substrate whose thickness is substantially 0.1 mm. Moreover, loading/unloading of optical disks to/from the plurality of optical disk devices may be performed at the same time or separately. For example, when four optical disks and four optical disk devices are used, even if the loading timing is different, information obtained first can be used and the next operation can be applied to the other optical disk devices.

According to the above-explained respective embodiments, the explanation was given of a case in which the array type disk device 100 includes the four optical disk devices, but the number of the optical disk devices is not limited to this number, and the array type disk device may include a plurality of optical disk devices.

Although the present invention was exemplarily explained as an optical disk device, the present invention is not limited to this type of device, and the same effect can be obtained if the present invention is applied to general disk devices.

The present invention can be changed and modified in various forms without departing from the broad scope and spirit of the present invention. The above-explained respective embodiments are for explaining the present invention, and are not for limiting the scope and spirit of the present invention. The scope and spirit of the present invention are indicated by attached claims rather than the embodiments. Various modifications within the scope and spirit of the present invention and the equivalent thereto are included in the scope and spirit of the present invention.

20[0129] The present application claims a priority based on Japanese Patent Application No. 2009-011434 filed on Jan. 21, 2009 and including specification, claims, drawings and abstract. The entire disclosure of this application is incorporated herein by reference in this application.

### INDUSTRIAL APPLICABILITY

The array type disk device and the control method for the same of the present invention can be utilized in order to execute high-speed and precise information processing on a plurality of optical disks.

### DESCRIPTION OF REFERENCE NUMERALS

10 Main control device
20, 20₁ to 20₄ Optical disk device
21 Spindle driving system
22 Optical head
22a Objective lens
22b Beam splitter
22c Optical receiver
22d Laser diode
22e, 22f Pre-amplifier
23 Servo controller
24 LD driver
25 RF circuit
25a Pre-filter
25b Automatic gain control circuit (AGC)
25c A/D converter (ADC)
25d Phase-locked loop circuit (PLL)
25e Adaptive equalizer
25f Discriminator
25g Memory circuit
25h Signal quality calculating circuit
25i Region determiner
25j Format determiner
25k Error rate calculator
26 Address detecting circuit
27 Stepper
28 Modulator
29 Demodulator
30 Drive control device
40 Disk convey means (accessor)
50 Holder
51, 51₁ to 51_{N} Cartridge
60, 60₁ to 60₄ Optical disk
60a Substrate
60b Center hole
61 Recording layer
62 Read-in area
63 Data area
64 Read-out area
100 Array type disk device
120 Upper-class device (host)

1. An array type disk device comprising:
a plurality of optical disk devices, wherein each of the plurality of optical disk devices records and reproduces information in and from an associated recording media; and
a controller configured to control the each of the plurality of optical disk devices to search for information relating to the associated recording media, respectively, when causing the each of the plurality of optical disk devices to execute information processing of the associated recording media, wherein each associated media comprises information of a same volume or a same content, to receive the searched information from at least one of the plurality of optical disk devices, to determine information based on the searched information, and to cause the each of the plurality of optical disk devices to start a next operation based on the determined information.

2. The array type disk device according to claim 1, wherein the determined information is the searched information from the optical disk device that is the first to complete the searching.

3. The array type disk device according to claim 1, wherein the determined information is the searched information of at least two optical disk devices, wherein the searched information of the at least two optical disk devices are determined to be similar with each other.

4. The array type disk device according to claim 1, wherein the determined information is determined based on mutually different information among the searched information by the plurality of optical disk devices, respectively, wherein the different information comprises different addresses in the associated recording media.

5. The array type disk device according to claim 1, wherein the determined information is information searched by the optical disk device that is first to complete searching when the respective optical disk devices are caused to search for the information relating to the respective recording media at different addresses in the respective recording media.

6. The array type disk device according to claim 1, wherein the plurality of optical disk devices are configured to search autonomously.

7. The array type disk device according to claim 1, wherein the determined information comprises management information including at least one of a location of data and contents of data.

8. The array type disk device according to claim 1, wherein the determined information comprises at least one of an end address of a region where data is recorded and a beginning address of a region where no data is recorded.

9. A control method for an array type disk device which comprises a plurality of optical disk devices and which performs information processing on a plurality of recording media loaded in the plurality of optical disk devices, each optical disk device having a same volume or a same content, the method comprising:
searching for information in each of the plurality of optical disk devices relating to the recording medium loaded in each of the plurality of the optical disk devices, respectively;
determining information to be determined information from the searched information; and
executing in each of the plurality of optical disk devices a next operation based on the determined information.

10. The control method for the array type disk device according to claim 9, wherein the determined information is determined to be the searched information of the optical disk device that is first to complete the searching.

11. The control method for the array type disk device according to claim 9, further comprising comparing the searched information from at least two optical disk devices, and determining if the searched information is similar to each other, wherein the determined information is determined to be the searched information if the searched information is similar to each other.

12. The control method for the array type disk device according to claim 9, wherein
searching for the information comprises searching for information relating to the recording medium at different address in the recording medium loaded in each of the plurality of optical disk devices; and
determining the information comprises determining the determined information based on mutually different information among the searched information.

13. The control method for the array type disk device according to claim 9, wherein determining the information
comprises receiving information on the recording medium loaded in each of the plurality of optical disk devices from at least one of the plurality of optical disk devices; and
determining the information received first as the determined information.

14. The control method for the array type disk device according to claim 9, wherein the determined information is management information including at least one of a location of data and contents of data.

15. The control method for the array type disk device according to claim 9, wherein the determined information comprises at least one of an end address of a region where data is recorded and a beginning address of a region where no data is recorded.
